(19) United States
(12) Patent Application Publication
(10) Pub. No.: US 2026/0264558 A1
(43) Pub. Date: Sep. 10, 2026

(54) ADAPTIVE CAPACITY TARIFF OPTIMIZATION

(71) Applicant: ABB E-Mobility B.V., Delft (NL)

(72) Inventor: Brecht BAETEN, Oudsbergen (BE)

(73) Assignee: ABB E-Mobility B.V., Delft (NL)

(21) Appl. No.: 19/165,966

(22) PCT Filed: Mar. 16, 2023
(86) PCT No.: PCT/EP2023/056719

§ 371 Date: Sep. 16, 2025

(51) Int. Cl. B60L 53/64; B60L 53/63; B60L 53/66

(52) U.S. Cl. CPC B60L 53/64; B60L 53/63; B60L 53/665

(57) ABSTRACT

In one aspect, a monitoring system for minimizing capacity-based electric costs for a utility service location is disclosed. The monitoring system is configured to identify a first peak electrical power delivered to the utility service location by an electric utility during a current capacity period, identify a second peak electrical power delivered to the utility service location by the electric utility during a prior capacity period, and calculate, based on the first peak electrical power and the second peak electrical power, an initial capacity limit. The monitoring system is further configured to identify an electrical power currently being provided to the utility service location by the electric utility, and dynamically vary a charging profile of at least one of an electric vehicle and a battery energy system electrically coupled to the utility service location to limit the electrical power currently being provided at or below the initial capacity limit.

### BACKGROUND

The field of the disclosure relates to charging electric vehicles and/or battery energy storage systems, and more particularly, to optimizing the charging of electric vehicles and/or battery energy storage systems to mitigate capacity tariff costs for end-users.

Due to the proliferation of electric vehicles and battery energy storage systems, electric utilities have begun implementing capacity tariffs, also referred to as demand tariffs, in order to control the peak electrical loads placed on the electrical grid due to charging electric vehicles and/or battery energy storage systems. A capacity or demand tariff is a pricing structure imposed on end-users that includes a demand charge for the use of the electrical grid. A capacity or demand charge is typically calculated based on the level of the demand placed on the electrical grid by a particular location (e.g., the end-user's home or office, referred to as service locations) during a specified monitoring time period or window. An electric utility may, for example, implement a capacity or demand charge when the electrical power supplied to the service location exceeds a pre-defined power threshold (e.g., ten kilowatts (kW)) for a pre-defined period of time (e.g., fifteen minutes) during the monitoring period (e.g., one month).

Because charging electric vehicles and battery energy storage systems at a service location can impart high electrical loads on the electric utility, an end-user may have difficulty mitigating the capacity tariffs imposed on the end-user by the electric utility, which may result in unexpected utility charges imposed on the end-user. Thus, it would be desirable to provide mechanisms for mitigating or minimizing such capacity tariffs for service locations that support charging electric vehicles and/or charging battery energy storage systems, such as the end-user's home or office.

### BRIEF DESCRIPTION

In one aspect, a monitoring system for minimizing capacity-based electric costs for a utility service location supplied by an electric utility is disclosed. The monitoring system comprises at least one processor configured to identify a first peak electrical power delivered to the utility service location by the electric utility during a current capacity period, identify a second peak electrical power delivered to the utility service location by the electric utility during a prior capacity period, and calculate, based on the first peak electrical power and the second peak electrical power, an initial capacity limit for the utility service location. The at least one processor is further configured to identify an electrical power currently being provided to the utility service location by the electric utility, and dynamically vary a charging profile of at least one of an electric vehicle and a battery energy system electrically coupled to the utility service location to limit the electrical power currently being provided at or below the initial capacity limit.

In another aspect, a method of minimizing capacity-based electric costs for a utility service location supplied by an electric utility is disclosed. The method comprises identifying a first peak electrical power delivered to the utility service location by the electric utility during a current capacity period, identifying a second peak electrical power delivered to the utility service location by the electric utility during a prior capacity period, and calculating, based on the first peak electrical power and the second peak electrical power, an initial capacity limit for the utility service location. The method further comprises identifying an electrical power currently being provided to the utility service location by the electric utility, and dynamically varying a charging profile of at least one of an electric vehicle and a battery energy system electrically coupled to the utility service location to limit the electrical power currently being provided at or below the initial capacity limit.

In another aspect, a system for minimizing capacity-based electric costs for a utility service location supplied by an electric utility is provided. The system comprises a cloud-based compute resource comprising at least one server, a power monitoring system, and a charge point. The power monitoring system is configured to monitor electrical power delivered to the utility service location by the electric utility. The charge point is electrically coupled to the utility service location, and the at least one server is configured to identify, utilizing the power monitoring system, a first peak electrical power delivered to the utility service location by the electric utility during a current capacity period, identify, utilizing the power monitoring system, a second peak electrical power delivered to the utility service location by the electric utility during a prior capacity period, and calculate, based on the first peak electrical power and the second peak electrical power, an initial capacity limit for the utility service location. The at least one server is further configured to identify, utilizing the power monitoring system, an electrical power currently being provided to the utility service location by the electric utility, and direct the charge point to dynamically vary a charging profile of an electric vehicle electrically coupled to the charge point to limit the electrical power currently being provided at or below the initial capacity limit.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 depicts a block diagram of a monitoring system for minimizing capacity-based costs for a utility service location supplied by an electric utility in an exemplary embodiment.

FIG. 2 depicts a block diagram of a monitoring system for minimizing capacity-based costs for a utility service location supplied by an electric utility in another exemplary embodiment.

FIG. 3 depicts a flow chart of a method of minimizing capacity-based costs for a utility service location supplied by an electric utility in an exemplary embodiment.

FIGS. 4-9 depict additional details of the method of FIG. 3 in exemplary embodiments.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, an analog computer, a programmable logic controller (PLC), an application specific integrated circuit (ASIC), and other programmable circuits, and these terms are used interchangeably herein. In the embodiments described herein, “memory” may include, but is not limited to, a computer-readable medium, such as a random-access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a touchscreen, a mouse, and a keyboard. Alternatively, other computer peripherals may also be used that may include, for example, but not be limited to, a scanner. Furthermore, in the example embodiment, additional output channels may include, but not be limited to, an operator interface monitor or heads-up display. Some embodiments involve the use of one or more electronic or computing devices. Such devices typically include a processor, processing device, or controller, such as a general-purpose central processing unit (CPU), a graphics processing unit (GPU), a microcontroller, a reduced instruction set computer (RISC) processor, an ASIC, a programmable logic controller (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are not intended to limit in any way the definition and/or meaning of the term processor and processing device.

As discussed previously, charging electric vehicles (EVs) and/or battery energy storage systems (BESS) often impart a significant electrical load on an electric utility, resulting in the power drawn from the electric utility at a service location (e.g., the end-user's home or office) exceeding, even if briefly, pre-defined capacity tariff levels that result in capacity charges being imposed on the end-user. For example, if a service location is subjected to a five kW capacity tariff, then during the evening hours when the end-user is typically using the largest amount of electrical power at home, the additional load on the electric utility from charging their EV or recharging their BESS can easily drive the power demand at the service location above the capacity tariff level, resulting in capacity charges being imposed by the electric utility on the end-user.

In the embodiments described herein, monitoring systems and a method are described that minimize capacity-based cost for a utility service location by dynamically varying a charging profile of EV(s) and/or BESS(s) to limit the electrical power being provided to the service location at or below an initial capacity limit. The initial capacity limit is calculated using one or more algorithms that account for the peak electrical power delivered to the service location during the current capacity tariff period and a prior capacity tariff period, such that the initial capacity limit is available at the beginning of the current capacity tariff period, instead of having to wait for a certain amount of time before mitigating possible capacity charges.

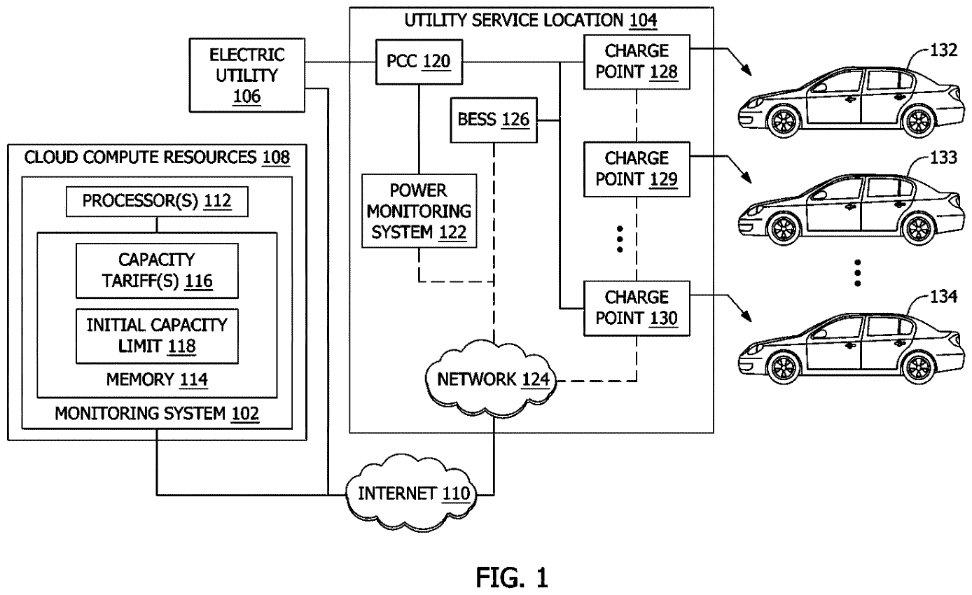

FIG. 1 depicts a block diagram of a monitoring system 102 for minimizing capacity-based costs for a utility service location 104 supplied by an electric utility 106 in an exemplary embodiment. Monitoring system 102 comprises any component, system, or device that performs the functionality described herein for monitoring system 102. Monitoring system 102 will be described with respect to various discrete elements, which perform functions. These elements may be combined in different embodiments or segmented into different discrete elements in other embodiments.

In this embodiment, monitoring system 102 is implemented using cloud compute resources 108. Cloud compute resources 108 comprise, for example, one or more cloud service providers (e.g., amazon web services (AWS), Microsoft Azure, etc.), which provide on-demand delivery of computing resources over Internet 110. Accordingly, monitoring system 102 in this embodiment may comprise one or more virtual machines executing on remote hardware managed by one or more cloud service providers.

In this embodiment, monitoring system 102 includes one or more processor 112 communicatively coupled to memory 114. Memory 114 stores one or more capacity tariffs 116 and an initial capacity limit 118. Capacity tariffs 116 are defined by electric utility 106, and specify the capacity-based or demand-based power levels and charges implemented on utility service location 104. For example, capacity tariffs 116 may be defined by electric utility 106 at one or more power levels (e.g., five kW, ten Kw, fifteen kW, etc.), and may include, for example, the capacity-based or demand-based charges associated with the amount of electrical power delivered in excess of a capacity tariff. Initial capacity limit 118 is calculated by processor 112 based on a number of factors, which will be discussed in more detail below.

In this embodiment, utility service location 104 includes a point of common coupling (PCC) 120, which is a point in the electrical power system at which the electric utility 106 and the customer interface occurs at utility service location 104. PCC 120 may be, for example, the customer side of a utility revenue meter.

In this embodiment, utility service location 104 includes a power monitoring system 122, which monitors the electrical power supplied by electric utility 106 to utility service location 104 at PCC 120. Power monitoring system 122 is communicatively coupled to a network 124 of utility service location 104 (e.g., a wired, wireless, or combination of wired and wireless network, such as Ethernet, Wi-Fi, etc.), which allows monitoring system 102 and power monitoring system 122 to communicate with each other. During operation, power monitoring system 122 monitors the real-time or near real-time electrical power delivered by electric utility 106 to utility service location 104 at PCC 120, and communicates this information to monitoring system 102.

In this embodiment, utility service location 104 includes a BESS 126 and one or more charge points 128, 129, 130. BESS 126 and charge points 128, 129, 130 communicate with monitoring system 102 via network 124 of utility service location 104 and Internet 110. BESS 126 and charge points 128, 129, 130 may provide various sensor data to monitoring system 102, including charging current levels, charging voltage levels, a state of charge (for BESS 126), etc.

BESS 126 includes one or more batteries, not shown, which are rechargeable. BESS 126 may act, for example, as a secondary power source for utility service location 104 when electric utility 106 is temporarily unable to provide electrical power to utility service location 104.

Charge points 128, 129, 130 are used to charge one or more EVs 132, 133, 134, respectively. Further, charge points 128, 129, 130 communicate with battery management systems of EVs 132, 133, 134 in some embodiments to control the rate of charging EVs 132, 133, 134. Generally, the rate of recharge of BESS 126 and the charge rate of EVs 132, 133, 134 are adjustable by monitoring system 102. In particular the rate of charge of BESS 126 and the charge rate of EVs 132, 133, 134 are adjusted by monitoring system 102 in real-time or near real-time based on the power supplied to utility service location 104 from electric utility 106 as measured by power monitoring system 122, in order to maintain the supplied power at or below initial capacity limit 118. This operates to minimize capacity tariffs 116 that the end-user may be subject to from electric utility 106. For example, if the initial capacity limit 118 is calculated as five kW, then monitoring system 102 dynamically adjusts the charge rate of EVs 132, 133, 134 (e.g., by communicating with charge points 128, 129, 130) and/or dynamically adjusts the charge rate of BESS 126 (e.g., by communicating with a charger of BESS 126) to maintain the power supplied to utility service location 104 by electric utility 106 (as measured at PCC 120 by power monitoring system 122) at or below initial capacity limit 118 of five kW.

As discussed briefly above, it is desirable to calculate initial capacity limit 118 upon startup of monitoring system 102 and/or at the beginning of a new capacity tariff period (e.g., a new capacity tariff period may begin at the start of each new month) in order to more accurately and efficiently dynamically adjust the power drawn by utility service location 104 from electric utility 106. For example, if historically if the peak power drawn by utility service location 104 is about ten kW, then it may be impossible or inefficient to initially modify the charge rates of EVs 132, 133, 134 and/or BESS 126 to maintain the power levels at or below, for example, six kW. Thus, in order to more realistically adjust the power drawn from electric utility 106, monitoring system 102 utilizes various algorithms in order to calculate initial capacity limit 118. In one such algorithm, processor 112 of monitoring system 102 may identify a first peak electrical power delivered to utility service location 104 during a current capacity period (e.g., during the current month). For example, processor 112 of monitoring system 102 may communicate with power monitoring system 122 and log the peak electrical power measured at PCC 120 over time in memory 114. In order to identify the first peak power, processor 112 may obtain the historical peak power information from memory 114 and/or directly from electric utility 106 (e.g., via Internet 110). Processor 112 may next identify a second peak electrical power delivered to utility service location 104 by electric utility 106 during a prior capacity tariff period (e.g., during the prior month). For example, processor 112 may obtain the historical peak power information from memory 114 and/or directly from electric utility 106 (e.g., via Internet 110). If the second peak electrical power is not known, processor 112 may obtain an estimated second peak power for the prior capacity tariff period that is based on a similarly configured utility service location.

Using the first peak power and the second peak power, processor 112 may calculate initial capacity limit 118 for utility service location 104. Processor 112 may then dynamically vary a charging profile of at least one of EVs 132, 133, 134 and BESS 126 in order to limit the electrically power being provided by utility service location 104 by electric utility 106 at or below initial capacity limit 118. For instance, if initial capacity limit 118 is five kW, then processor 112 may communicate with power monitoring system 122 to obtain the electrical power currently being delivered to utility service location 104 at PCC 120, communicate with charge points 128, 129, 130 to dynamically vary the charging profile of EVs 132, 133, 134, respectively, and/or communicate with BESS 126 to dynamically vary the charging profile of BESS 126 in order to maintain the power supplied to utility service location 104 by electric utility 106 at or below initial capacity limit 118.

In some embodiments, processor 112 of monitoring system 102 calculates initial capacity limit 118 based on a higher of the first peak electrical power and the second peak electrical power. For example, if the second peak power in the prior capacity period was twelve kW and the first peak power in the current capacity period is five kW, then processor 112 of monitoring system 102 may use the higher of the two, i.e., twelve kW, as initial capacity limit 118. Processor 112 may communicate with power monitoring system 122 to obtain the electrical power currently being delivered to utility service location 104 at PCC 120, communicate with charge points 128, 129, 130 to dynamically vary the charging profile of EVs 132, 133, 134, respectively, and/or communicate with BESS 126 to dynamically vary the charging profile of BESS 126 in order to maintain the power supplied to utility service location 104 by electric utility 106 at or below twelve kW.

In other embodiments, processor 112 of monitoring system 102 calculates initial capacity limit 118 based on a higher of the first peak electrical power, the second peak electrical power, and capacity tariffs 116. For example, if the second peak power in the prior capacity period was twelve kW, the first peak power in the current capacity period is five kW, but capacity tariff 116 is fifteen kW, then processor 112 of monitoring system 102 may use the higher of the three, i.e., fifteen kW, as initial capacity limit 118. This allows processor 112 to dynamically vary the charging profile for EVs 132, 133, 134 and/or BESS 126 up to the fifteen kW tariff entry point without the end-user incurring additional capacity-based charges from electric utility 106.

Processor 112 may communicate with power monitoring system 122 to obtain the electrical power currently being delivered to utility service location 104 at PCC 120, communicate with charge points 128, 129, 130 to dynamically vary the charging profile of EVs 132, 133, 134, respectively, and/or communicate with BESS 126 to dynamically vary the charging profile of BESS 126 in order to maintain the power supplied to utility service location 104 by electric utility 106 at or below fifteen kW.

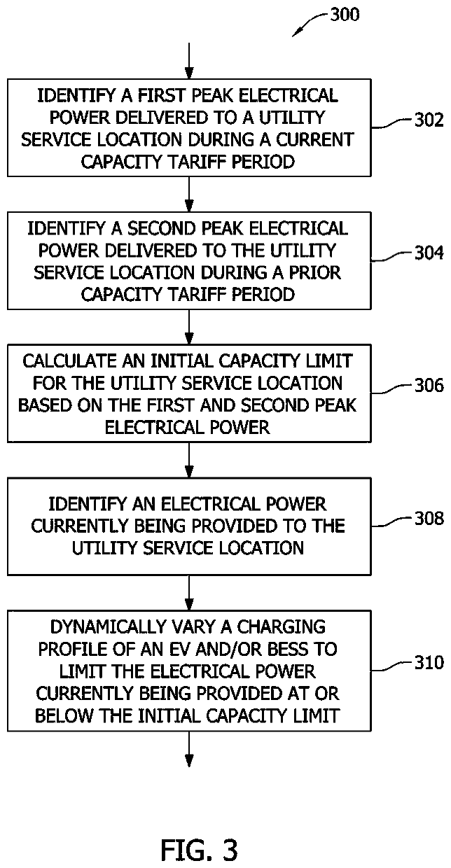

In some embodiments, processor 112 dynamically varies the charging profile of EVs 132, 133, 134 by transmitting, utilizing the respective charge points 128, 129, 130, one or more requests to a battery management system (not shown) of EVs 132, 133, 134, where the requests specify an allowable current that may be drawn by the EVs 132, 133, 134 from charge points 128, 129, 130, respectively. For example, processor 112 may request, via charge point 128, that EV 132 draw no more than twenty amps from charge point 128 in order to maintain the power drawn by utility service location 104 from electric utility 106 at or below initial capacity limit 118. These and other operational features of monitoring system 102 will be discussed in more detail below with respect to FIGS. 3-9.

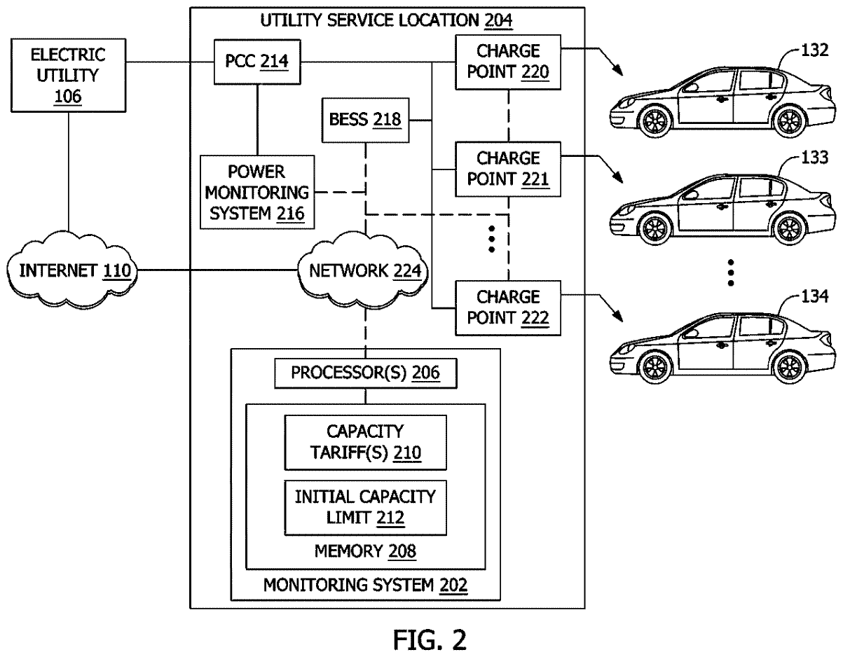

FIG. 2 depicts a block diagram of a monitoring system 202 for minimizing capacity-based costs for a utility service location 204 supplied by electric utility 106 in another exemplary embodiment. Monitoring system 202 comprises any component, system, or device that performs the functionality described herein for monitoring system 202. Monitoring system 202 will be described with respect to various discrete elements, which perform functions. These elements may be combined in different embodiments or segmented into different discrete elements in other embodiments.

In this embodiment, monitoring system 202 includes a processor 206 and a memory 208 storing capacity tariffs 210 and an initial capacity limit 212, each of which may operate similarly to that previously described for processor 112, memory 114, capacity tariffs 116, and initial capacity limit 118, respectively, for FIG. 1. Utility service location 204 includes a PCC 214, a power monitoring system 216, a BESS 218, one or more charge points 220, 221, 222, and a network 224, each of which may operate similarly to that previously described for PCC 120, power monitoring system 122, BESS 126, charge points 128, 129, 130, and network 124, respectively, for FIG. 1. Charge points 220, 221, 222 are electrically coupled to EVs 132, 133, 134, respectively.

In this embodiment, monitoring system 202 operates locally at utility service location 204. For example, monitoring system 202 may comprise one or more servers or other dedicated hardware at utility service location 204. In some embodiments, monitoring system 202 is part of power monitoring system 216. In this embodiment, monitoring system 202 operates similarly as monitoring system 102 of FIG. 1, although monitoring system 202 is implemented locally at utility service location 204.

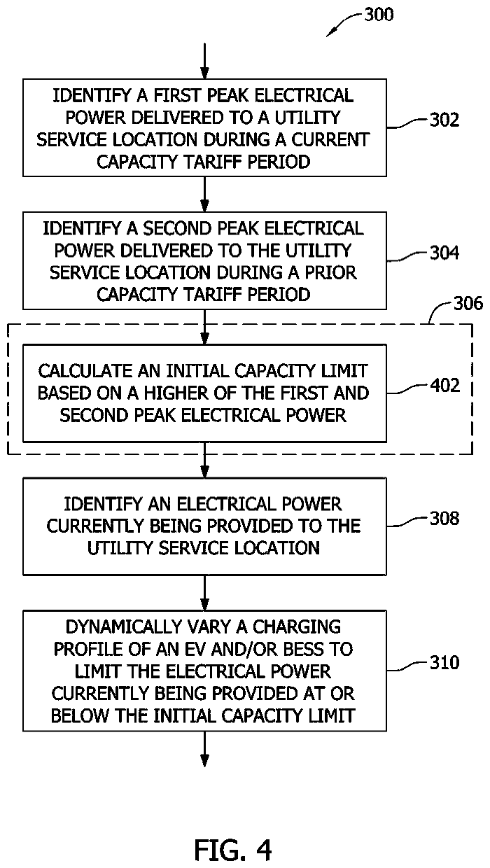

FIG. 3 depicts a flow chart of a method 300 of minimizing capacity-based costs for a utility service location supplied by an electric utility in an exemplary embodiment. FIGS. 4-9 depict additional details of method 300 of FIG. 3 in exemplary embodiments. Method 300 will be described with respect to monitoring system 102, although method 300 may be performed by other systems, not shown. The discussion of method 300 with respect to monitoring system 102 of FIG. 1 applies equally to monitoring system 202 of FIG. 2.

Method 300 begins in this embodiment by identifying 302 a first peak electrical power delivered to the utility service location during a current capacity tariff period. For example, processor 112 utilizes power monitoring system 122 to log power measured at PCC 120 at memory 114, which is used to identify the first peak electrical power for the current capacity tariff period. Processor 112 may also communicate with electric utility 106 via Internet 110 to obtain the first peak electrical power for the current capacity tariff period.

Method 300 continues in this embodiment by identifying 304 a second peak electrical power delivered to the utility service location by the electric utility during a prior capacity tariff period. For example, processor 112 utilizes power monitoring system 122 to log power measured at PCC 120 at memory 114, which is used to identify the second peak electrical power for the prior capacity tariff period (e.g., a previous month). Processor 112 may also communicate with electric utility 106 via Internet 110 to obtain the second peak electrical power for the prior capacity tariff period.

Method 300 continues in this embodiment by calculating 306, based on the first peak electrical power and the second peak electrical power, an initial capacity limit for the utility service location. For example, processor 112 calculates initial capacity limit 118 based on the first peak electrical power and the second peak electrical power.

Method 300 continues in this embodiment by identifying 308 an electrical power currently being provided to the utility service location by the electric utility. For example, processor 112 communicates with power monitoring system 122 to identify the electrical power currently being provided to utility service location 104 by electric utility 106.

Method 300 continues in this embodiment by dynamically varying 310 a charging profile of at least one of an EV and a BESS electrically coupled to the utility service location to limit the electrical power currently being provided at or below the initial capacity limit. For example, processor 112 communicates with charge points 128, 129, 130, to dynamically vary the charging profile of EVs 132, 133, 134, respectively, and/or communicates with BESS 126 to dynamically vary its charging profile in order to maintain the electrical power drawn from electric utility 106 by utility service location 104 at or below initial capacity limit 118.

In an optional embodiment of method 300, the initial capacity limit is calculated 402 (see FIG. 4) based on the higher of the first peak electrical power and the second peak electrical power. For example, if the first peak electrical power is ten kW and the second peak electrical power is fifteen kW, then processor 112 sets initial capacity limit 118 to the higher value of fifteen kW.

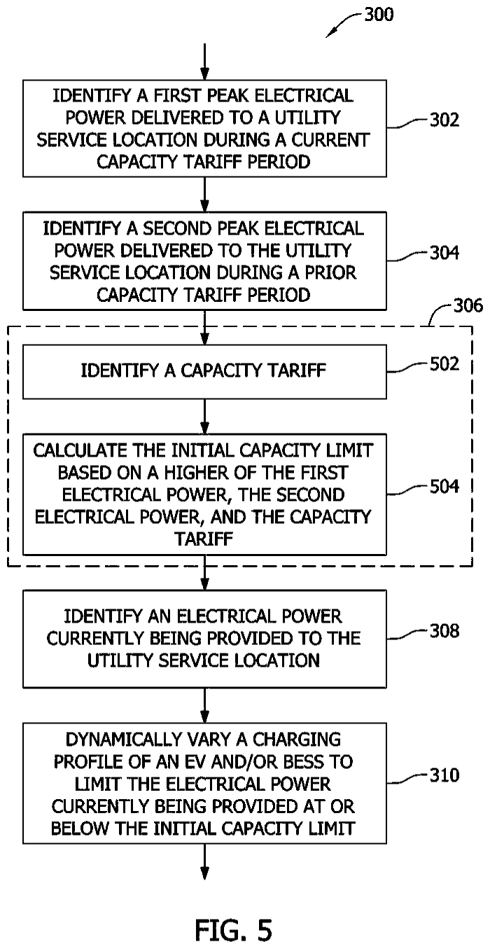

In another optional embodiment of method 300, the initial capacity limit is calculated by identifying 502 (see FIG. 5) a capacity tariff and calculating 504 the higher of the capacity limit, the first peak electrical power and the second peak electrical power. For example, if the first peak electrical power is ten kW, the second peak electrical power is fifteen kW, and capacity tariff 116 is five kW, then processor 112 sets initial capacity limit 118 to the higher value of fifteen kW.

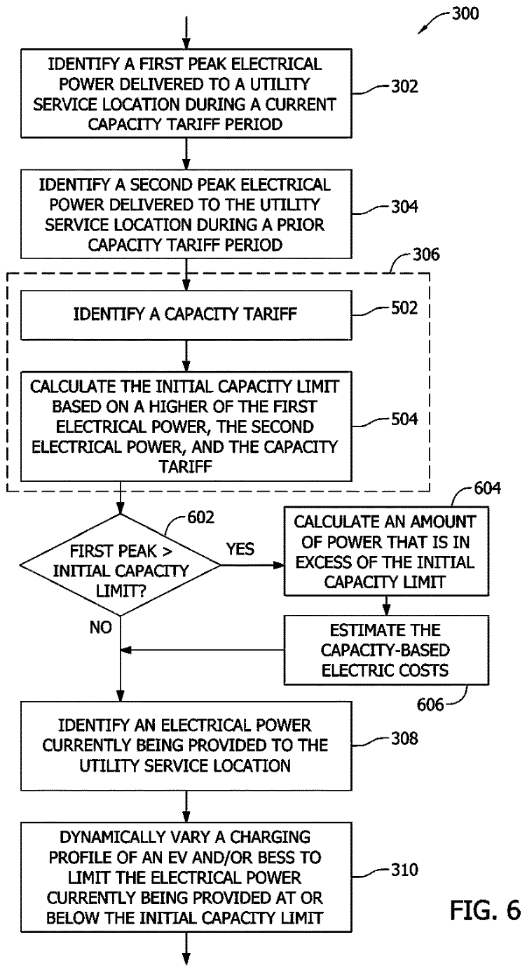

In continuing with this optional embodiment, method 300 further comprises determining 602 (see FIG. 6) that the first peak electrical power exceeds the initial capacity limit during the current capacity tariff period, calculating 604 an amount of electrical power delivered to the utility service location by the electrical utility that is in excess of the initial capacity limit, and estimating 606 the capacity-based electric cost for the utility service location based on the capacity tariff and the amount of electrical power delivered. For example, processor 112 communicates with power monitoring system 122 to monitor the electrical power delivered by electric utility 106 to utility service location 104 at PCC 120 during the current capacity tariff period, and determines that the first peak electrical power exceeds initial capacity limit 118 previously calculated based on the higher of the first electrical power, the second electrical power, and capacity tariff 116. Processor 112 calculates the amount of power that is excess of initial capacity limit 118, and estimates the capacity-based electric costs for utility service location 104 based on capacity tariff 116 and the amount of electrical power delivered.

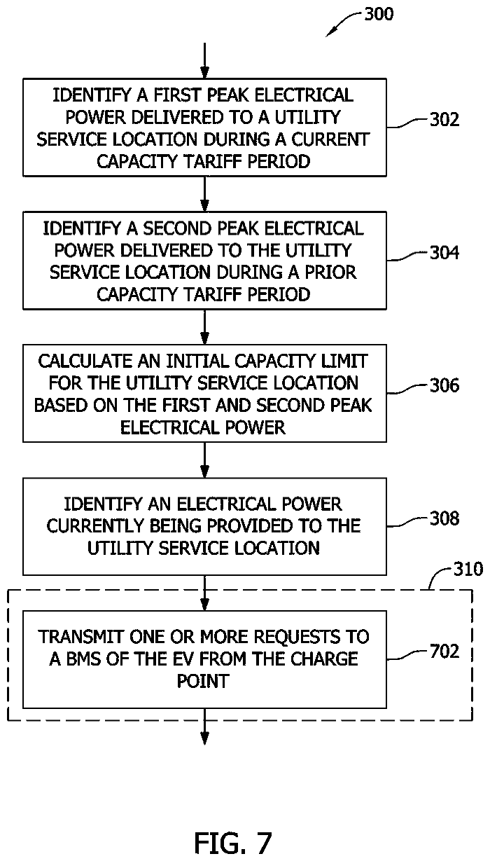

In another optional embodiment of method 300, dynamically varying the charging profile of an EV and/or BESS is performed by transmitting 702 (see FIG. 7), utilizing a charging point of the utility service location, one or more requests to a battery management system of the EV, where the one or more requests specify an allowable current that may be drawn by the EV from the charge point. For example, processor 112 of monitoring system 102 (see FIG. 1) transmits, using charge point 128, one or more requests to a battery management system of EV 132 (not shown), to specify an allowable current that may be drawn by EV 132 from charge point 128. Multiple requests may be sent over time in order to dynamically vary the charging profile for EV 132 and maintain the current at PCC 120 at or below initial capacity limit 118.

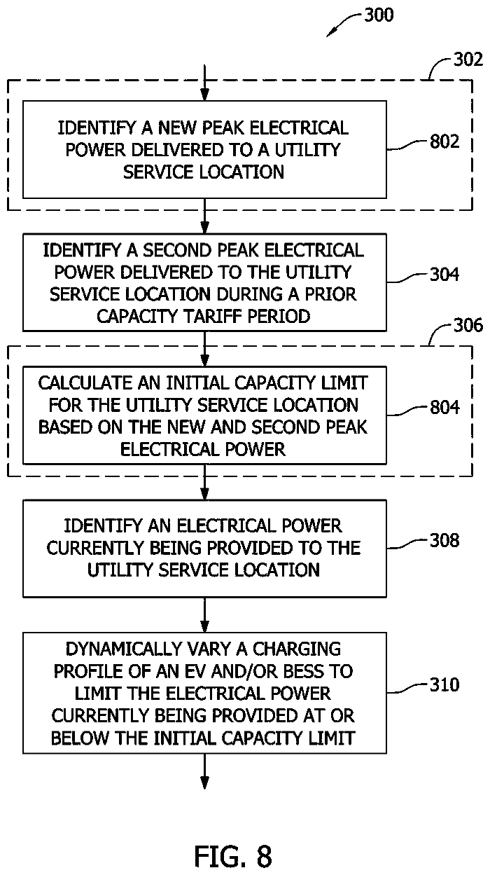

In another optional embodiment of method 300, identifying the first peak electrical power during the current capacity tariff period is performed by identifying 802 (see FIG. 8) a new peak electrical power delivered to the utility service location by the electric utility during the current capacity tariff period, and calculating the initial capacity limit is performed by calculating 804, based on the new peak electrical power and the second peak electrical power, the initial capacity limit for the utility serviced location. For example, during operation within the current capacity tariff period, processor 112 may first determine that the peak power provided to utility service location 104 is about seven kW, and subsequently, identify that the peak power delivered is higher at a future time (due to unforeseen loads at utility service location 104 and/or expedited charging of EVs 132, 133, 134 and/or BESS 126), of about twelve kW. As a result, processor 112 re-calculates initial capacity limit 118 as the higher value of twelve kW.

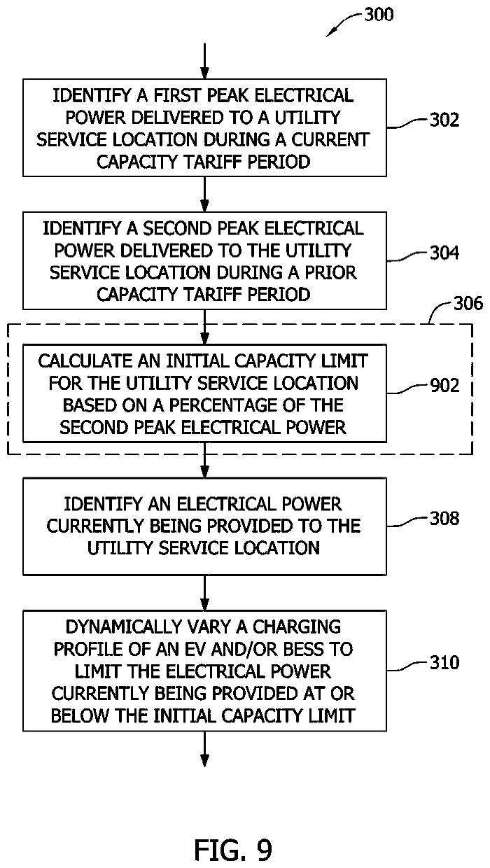

In another optional embodiment, method 300 further comprises calculating 902 (see FIG. 9) the initial capacity limit based on a percentage of the second peak electrical power, where the percentage is less than one hundred percent. For example, if processor 112 determines that the second peak electrical power during the prior capacity tariff period is ten kW, then processor 112 may set initial capacity limit 118 to a percentage of this value (e.g., ninety percent) in order to encourage the end-user at utility service location 104 to conserve more electricity during the current capacity tariff period.

An example technical effect of the embodiments described herein includes at least one of: (a) utilizing various algorithms to calculate an initial capacity limit for a utility service location, which is used to dynamically vary a charging profile for one or more of a BESS and EV; (b) dynamically adjusting the charging profile(s) over time as the initial capacity limit is adjusted based on the varying power demand at the utility service location; and (c) implementing the initial capacity limit based on historical information and/or similar utility service locations in order to perform dynamic charging and reduce the end-users exposure to capacity tariffs.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A monitoring system for minimizing capacity-based electric costs for a utility service location supplied by an electric utility, the monitoring system comprising:
at least one processor configured to:
identify a first peak electrical power delivered to the utility service location by the electric utility during a current capacity tariff period;
identify a second peak electrical power delivered to the utility service location by the electric utility during a prior capacity tariff period;
calculate, based on the first peak electrical power and the second peak electrical power, an initial capacity limit for the utility service location;
identify an electrical power currently being provided to the utility service location by the electric utility; and
dynamically vary a charging profile of at least one of an electric vehicle and a battery energy storage system electrically coupled to the utility service location to limit the electrical power currently being provided at or below the initial capacity limit.

2. The monitoring system of claim 1, wherein the at least one processor is further configured to:
calculate, based on a higher of the first peak electrical power and the second peak electrical power, the initial capacity limit for the utility service location.

3. The monitoring system of claim 1, wherein the at least one processor is further configured to:
identify a capacity tariff for the current capacity tariff period; and
calculate, based on a higher of the first peak electrical power, the second peak electrical power, and the capacity tariff, the initial capacity limit for the utility service location.

4. The monitoring system of claim 3, wherein the at least one processor is further configured to:
determine that the first peak electrical power exceeds the initial capacity limit during the current capacity tariff period;
calculate an amount of electrical power delivered to the utility service location by the electrical utility that is in excess of the initial capacity limit; and
estimate the capacity-based electric costs for the utility service location based on the capacity tariff and the amount of electrical power delivered.

5. The monitoring system of claim 1, wherein the at least one processor is further configured to:
dynamically vary the charging profile of the electric vehicle by transmitting, utilizing a charge point of the utility service location, one or more requests to a battery management system of the electric vehicle, wherein the one or more requests specify an allowable current that may be drawn by the electric vehicle from the charge point.

6. The monitoring system of claim 1, wherein the at least one processor is further configured to:
identify a new peak electrical power delivered to the utility service location by the electric utility during the current capacity tariff period; and
calculate, based on the new peak electrical power and the second peak electrical power, the initial capacity limit for the utility service location.

7. The monitoring system of claim 1, wherein the at least one processor is further configured to:
calculate the initial capacity limit for the utility service location based on a percentage of the second peak electrical power, wherein the percentage is less than one hundred percent.

8. A method of minimizing capacity-based electric costs for a utility service location supplied by an electric utility, the method comprising:
identifying a first peak electrical power delivered to the utility service location by the electric utility during a current capacity tariff period;
identifying a second peak electrical power delivered to the utility service location by the electric utility during a prior capacity tariff period;
calculating, based on the first peak electrical power and the second peak electrical power, an initial capacity limit for the utility service location;
identifying an electrical power currently being provided to the utility service location by the electric utility; and
dynamically varying a charging profile of at least one of an electric vehicle and a battery energy storage system electrically coupled to the utility service location to limit the electrical power currently being provided at or below the initial capacity limit.

9. The method of claim 8, wherein calculating the initial capacity limit further comprises:
calculating, based on a higher of the first peak electrical power and the second peak electrical power, the initial capacity limit for the utility service location.

10. The method of claim 8, wherein calculating the initial capacity limit further comprises:
identifying a capacity tariff for the current capacity tariff period; and
calculating, based on a higher of the first peak electrical power, the second peak electrical power, and the capacity tariff, the initial capacity limit for the utility service location.

11. The method of claim 10, further comprising:
determining that the first peak electrical power exceeds the initial capacity limit during the current capacity tariff period;
calculating an amount of electrical power delivered to the utility service location by the electrical utility that is in excess of the initial capacity limit; and
estimating the capacity-based electric costs for the utility service location based on the capacity tariff and the amount of electrical power delivered.

12. The method of claim 8, wherein dynamically varying the charging profile of the at least one of the electric vehicle and the battery energy storage system further comprises:
transmitting, utilizing a charge point of the utility service location, one or more requests to a battery management system of the electric vehicle, wherein the one or more requests specify an allowable current that may be drawn by the electric vehicle from the charge point.

13. The method of claim 8, wherein:
identifying the first peak electrical power further comprises:
identifying a new peak electrical power delivered to the utility service location by the electric utility during the current capacity tariff period; and
calculating the initial capacity limit further comprises:
calculating, based on the new peak electrical power and the second peak electrical power, the initial capacity limit for the utility service location.

14. The method of claim 8, wherein calculating the initial capacity limit further comprises:
calculating the initial capacity limit for the utility service location based on a percentage of the second peak electrical power, wherein the percentage is less than one hundred percent.

15. A system for minimizing capacity-based electric costs for a utility service location supplied by an electric utility, the system comprising:
a cloud-based compute resource comprising at least one server;
a power monitoring system configured to monitor electrical power delivered to the utility service location by the electric utility; and
a charge point electrically coupled to the utility service location,
wherein the at least one server is configured to:
identify, utilizing the power monitoring system, a first peak electrical power delivered to the utility service location by the electric utility during a current capacity tariff period;
identify, utilizing the power monitoring system, a second peak electrical power delivered to the utility service location by the electric utility during a prior capacity tariff period;
calculate, based on the first peak electrical power and the second peak electrical power, an initial capacity limit for the utility service location;
identify, utilizing the power monitoring system, an electrical power currently being provided to the utility service location by the electric utility; and
direct the charge point to dynamically vary a charging profile of an electric vehicle electrically coupled to the charge point to limit the electrical power currently being provided at or below the initial capacity limit.

16. The system of claim 15, further comprising:
a battery energy storage system electrically coupled to the utility service location,
wherein the at least one server is further configured to:
direct the battery energy storage system to dynamically vary its charging profile to limit the electrical power currently being provided at or below the initial capacity limit.

17. The system of claim 15, wherein the at least one server is further configured to:
calculate, based on a higher of the first peak electrical power and the second peak electrical power, the initial capacity limit for the utility service location.

18. The system of claim 15, wherein the at least one server is further configured to:
identify a capacity tariff for the current capacity tariff period; and
calculate, based on a higher of the first peak electrical power, the second peak electrical power, and the capacity tariff, the initial capacity limit for the utility service location.

19. The system of claim 15, wherein the at least one server is further configured to:
identify, utilizing the power monitoring system, a new peak electrical power delivered to the utility service location by the electric utility during the current capacity tariff period; and
calculate, based on the new peak electrical power and the second peak electrical power, the initial capacity limit for the utility service location.

20. The system of claim 15, wherein the at least one server is further configured to:
calculate the initial capacity limit for the utility service location based on a percentage of the second peak electrical power, wherein the percentage is less than one hundred percent.
